(19) United States
(12) Patent Application Publication
(10) Pub. No.: US 2006/0044626 A1
(43) Pub. Date: Mar. 2, 2006

(54) Image reading device and image forming apparatus

(75) Inventors: Nobuya Kishi, Yamatokoriyama-shi (JP); Takanori Yoshimura, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/212,658

(22) Filed: Aug. 29, 2005

(30) Foreign Application Priority Data
Aug. 30, 2004 (JP) 2004-250817

(51) Int. Cl. H04N 1/04

(52) U.S. Cl. 358/474

(57) ABSTRACT

The image reading device is provided with a plurality of image reading portions, a storage portion, and an image processing portion. The image reading portions are provided with a plurality of light receiving elements that are each lined up in the main scanning direction perpendicular to the original transport direction, and read an image on an original that is being transported on an original transport path, in positions that mutually differ in the original transport direction. The storage portion stores, as temporary image data, each of a plurality of image data sets relating to the image on the original, obtained through the plurality of image reading portions. The image processing portion compares the plurality of temporary image data sets for each pixel, and creates image data relating to the image on the original based on a result of the comparison.

### CROSS REFERENCE

This Nonprovisional application claims priority under 35 U.S.C. §119(a) on Patent Application No. 2004-250817 filed in Japan on Aug. 30, 2004, the entire contents of which are hereby incorporated by reference.

### BACKGROUND OF THE INVENTION

The present invention relates to an image reading device provided with a function for reading an image on an original that is being transported on an original transport path, and an image forming apparatus provided with the image reading device.

When reading an image on an original that is being transported on an original platen, there has been the problem that image data relating to the image on the original cannot be accurately obtained if the original platen is dirty or scratched. For example, black streaks often appear in images printed on paper in accordance with the acquired image data, caused by dirt or scratches on the original platen.

Therefore, JP 2001-339582A has disclosed techniques for suppressing the appearance of black streaks in images printed on paper by providing two CCD sensors for reading images and selectively using the CCD sensor that is less affected by dirt or scratches on the original platen.

However, the techniques described in JP 2001-339582A cannot prevent black streaks from appearing in images printed on paper when all the CCD sensors are affected by dirt or scratches on the original platen.

It is an object of the present invention to provide an image reading device capable of reading an image on an original substantially without being affected by dirt or scratches present on the original platen, and an image forming apparatus provided with the image reading device.

### SUMMARY OF THE INVENTION

The image reading device according to the present invention is an image reading device provided with a function for reading an image on an original that is being transported on an original transport path. The image reading device has a plurality of image reading portions, a storage portion, and an image processing portion. The plurality of image reading portions are each provided with a plurality of light receiving elements that are each lined up in the main scanning direction perpendicular to an original transport direction. The image reading portions read an image on an original that is being transported on the original transport path, in positions that mutually differ in the original transport direction. The storage portion stores, as temporary image data, each of a plurality of image data sets relating to the image on the original, obtained through the image reading portions. The image processing portion compares the plurality of temporary image data sets for corresponding pixels, and creates image data relating to the image on the original based on the result of the comparison.

Examples of a method for creating image data relating to an image on an original include a method by which one of the values for each pixel in a plurality of temporary image data sets is selected as image data and a method by which the values for each pixel in a plurality of temporary image data sets are averaged. The value of each corresponding pixel of the image data sets is compared with each other, and the value of the image data is determined for each pixel based on the result of the comparison. By determining the value of the image data for each pixel in this manner, image data adequately corresponding to an image on an original is created even when all temporary image data sets are affected by dirt or scratches on the original platen.

### BRIEF DESCRIPTION OF THE DRAWINGS

FIG. 1 is a view showing a structural overview of an image reading device and an image forming apparatus, according to a first embodiment;

FIG. 2 is an enlarged view showing a CCD image sensor in the image reading device;

FIG. 3 is a view showing the configuration in the vicinity of original reading positions in the image reading device;

FIG. 4 is a block diagram schematically showing a configuration of the image forming apparatus;

FIG. 5A to FIG. 5G are explanatory diagrams showing how the image reading device operates in a second reading mode;

FIG. 6 is a flowchart showing an example of the operating procedure performed by the image reading device in the second reading mode;

FIG. 7 is a flowchart showing an example of the operating procedure performed by the image reading device in the second reading mode;

FIG. 8 is an explanatory diagram showing the coordinates of pixels in image data relating to an image on an original;

FIGS. 9A and 9B are views showing examples of a method for creating image data from the temporary image from a plurality of temporary image data sets;

FIG. 10 is a view showing an example of a method for creating image data;

FIG. 11 is a flowchart showing the operating procedure performed by the image reading device, according to a second embodiment; and

FIG. 12 is an enlarged view of a CCD image sensor of the image reading device.

### DESCRIPTION OF THE INVENTION

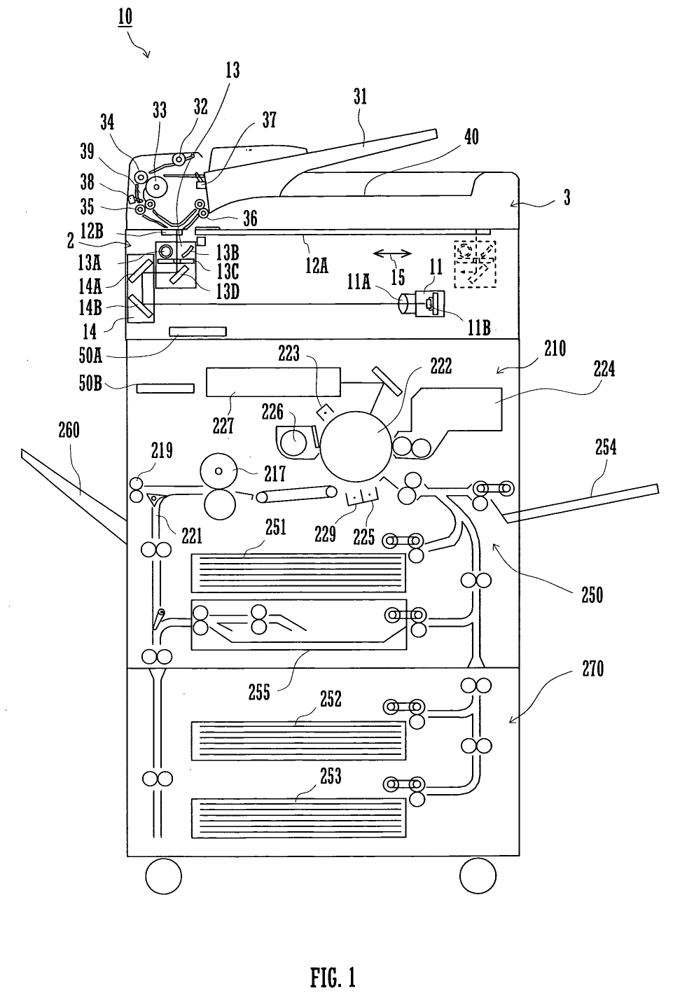

As shown in FIG. 1, an image forming apparatus 10 is provided with an image reading device 2, an automatic original transport device 3, an image forming portion 210, and a multi-stage paper feeding portion 270.

Platen glasses 12A and 12B made of transparent glass are provided on the upper face of the image reading device 2. The platen glass 12A is used in a first reading mode in which an image on an original is read while the original is at rest. The platen glass 12B is used in a second reading mode in which an image on an original is read while the original is being transported.

A first scanning unit 13, a second scanning unit 14, a reading sensor unit 11, and a control portion 50A are arranged below the platen glasses 12A and 12B.

The first scanning unit 13 is provided with a lamp 13A, a reflector 13B, a plate 13C that has a slit, and a first mirror 13D. The lamp 13A illuminates light onto an original on the platen glass 12A or 12B. The reflector 13B converges the light illuminated by the lamp 13A. The plate 13C focuses the light reflected by the original, via the slit. The first mirror 13D guides the reflected light from the original to the second scanning unit 14.

The second scanning unit 14 is provided with a second mirror 14A and a third mirror 14B. The second mirror 14A and the third mirror 14B guide the light reflected by the original that is then reflected by the first mirror 13D to the reading sensor unit 11.

The reading unit sensor 11 is provided with an imaging lens 11A and a CCD image sensor 11B. The imaging lens 11A focuses an image of the light reflected by the original onto the CCD image sensor 11B. The CCD image sensor 11B is a photoelectric transducer, and it photoelectrically converts the incident light reflected by the original to be output as image data.

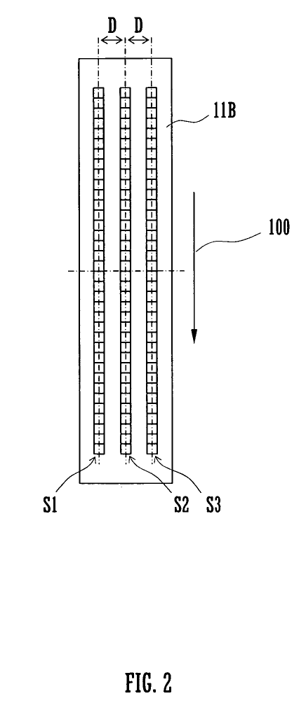

As shown in FIG. 2, the CCD image sensor 11B is provided with a plurality of CCD line sensors S1 to S3. In this embodiment, the three CCD line sensors S1 to S3 are formed in one piece. Herein, each of the CCD line sensors S1 to S3 constitutes an image reading portion of the present invention.

Each of the CCD line sensors S1 to S3 is provided with a plurality of elements arranged in the main scanning direction shown by an arrow 100. Each of the CCD line sensors S1 to S3 continuously acquires, in the original transport direction, temporary image data in units of one line at a time in the main scanning direction of the image on the original. The CCD line sensors S1 to S3 are arranged in parallel with each other, having intervals D therebetween. In this embodiment, the interval D is set to be a value equivalent to the width of eight lines as read by the CCD line sensors S1 to S3.

The interval D is set in accordance with the degree of resolution that is read by the CCD line sensors S1 to S3. When the interval D is made larger, there is an advantage that a single scratch or dirt present on the platen glass 12B becomes less likely to affect all of the temporary image data acquired by the CCD line sensors S1 to S3. On the other hand, when the interval D is made larger, the range of the image that is, read by the CCD image sensor 11B and the range of the lightning on the original increase, and thus a plurality of acquired temporary image data sets are more likely to be affected by irregularities in the speed at which the original is transported and by irregularities in the lighting.

The width of the eight lines employed in this embodiment is often set as the interval between CCD line sensors in the case of general CCD image sensors for color images, thus it is easy to make use of general CCD image sensors for color images as the CCD image sensor 11B in the image reading device 2 of the present invention.

The operation of the image reading device 2 will be described with reference to FIG. 1. In the first reading mode, the first scanning unit 13 runs along the platen glass 12A in the original transport direction indicated by the arrow 15 at a velocity V. At this time, the second scanning unit 14 runs in the same direction at a velocity V/2. The first scanning unit 13, the second scanning unit 14, and the reading sensor unit 11 read the image on the original that is on the platen glass 12A.

Furthermore, in the second reading mode, the first scanning unit 13 and the second scanning unit 14 read the image on the original that is being transported on the platen glass 12B, while they are stationary at a predetermined position below the platen glass 12B.

The automatic original transport device 3 is disposed above the platen glasses 12A and 12B. The automatic original transport device 3 is constituted as a single piece that includes an original cover for holding down an original that is placed on the platen glass 12A. The automatic original transport device 3 is provided with an original tray 31 and an original discharge tray 40. The original tray 31 holds originals that are to be read in the second reading mode. The original discharge tray 40 holds originals that have been read in the second reading mode.

The automatic original transport device 3 is provided with a curved transport path 39 from the original tray 31 via the original reading positions on the platen glass 12B to the original discharge tray 40. An original detector 37, a pick-up roller 32, a paper feeding roller 33, a separation roller 34, an original transport timing detector 38, registration rollers 35, and discharge rollers 36 are arranged along this transport path 39. The original detector 37 is disposed at the starting point of the transport path 39, and it detects that an original has been placed on the original tray 31. The pick-up roller 32 sends the original that is placed on the original tray 31 into the transport path 39 at the start of the reading operation. The paper feeding roller 33 and the separation roller 34 prevent double sending of the originals sent into the transport path 39. The original transport timing detector 38 detects that the front edge of the original has reached the position of the registration rollers 35. The registration rollers 35 transport the original to the image reading positions on the platen glass 12B, matched to the reading timing of the image reading device 2. The discharge rollers 36 discharge the original that has been read into the discharge tray 40.

The image forming portion 210 is disposed below the image reading device 2. The image forming portion 210 is provided with a first paper feeding cassette 251, a manual tray 254, and a discharge tray 260. Furthermore, a paper transport path 250 for transporting paper is formed inside the image forming portion 210. The image forming portion 210 is provided with a photosensitive drum 222, a charger 223, a laser writing unit 227, a developer 224, a transfer unit 225, a decharger 229, and a cleaner 226. The photosensitive drum 222 is an image carrier for carrying an image, and this rotates in the clockwise direction of FIG. 1. The charger 223 charges the peripheral face of the photosensitive drum 222 to a predetermined potential. The laser writing unit 227 illuminates laser light in accordance with image data supplied from the control portion 50 or an external device to form a static latent image based on the supplied image data, on the peripheral face of the photosensitive drum 222. It should be noted that instead of the laser writing unit 227, an array of light-emitting elements such as LEDs or ELs may be used. The developer 224 supplies toner to the static latent image formed on the photosensitive drum 222 to form a toner image. The transfer unit 225 transfers the toner image formed on the surface of the photosensitive drum 222 to paper. The decharger 229 decharges the potential that is no longer required and that is residual on the photosensitive drum 222 after the toner image has been transferred. The cleaner 226 recovers excess toner that is residual on the photosensitive drum 222.

A fixing unit 217 and discharge rollers 219 are arranged downstream of the photosensitive drum 222 on the paper transport path 250. The fixing unit 217 fixes the toner image that has been attached to the paper onto the paper using heat and pressure. The discharge rollers 219 discharge the paper that has passed through the fixing unit 217 to the discharge tray 260. A junction leading to a switch back path 221 is disposed between the fixing unit 217 and the discharge rollers 219 on the paper transport path 250. The switch back path 221 is connected to an intermediate unit 255. The paper that has been guided to the switch back path 221 is transported again, via the intermediate unit 255, to the gap between the photosensitive drum 222 and the transfer unit 225.

The multi-stage paper feeding portion 270 is disposed below the image forming portion 210. The multi-stage paper feeding portion 270 is provided with a second paper feeding cassette 252 and a third paper feeding cassette 253.

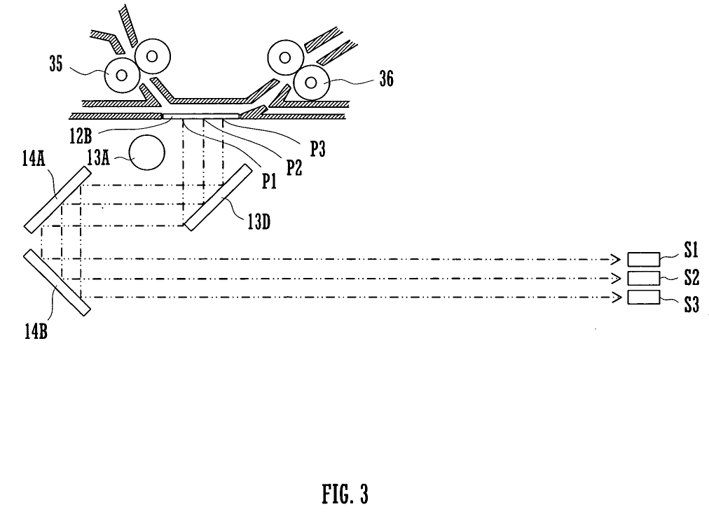

A process of reading an original in the second reading mode will be described with reference to FIG. 3. As shown in FIG. 3, in the second reading mode, the three CCD line sensors S1 to S3 read an image on an original at mutually different image reading positions P1 to P3. The image reading positions P1 to P3 are arranged at different positions in the paper transport direction. The three CCD line sensors S1 to S3 create three image data sets with respect to an image on one original.

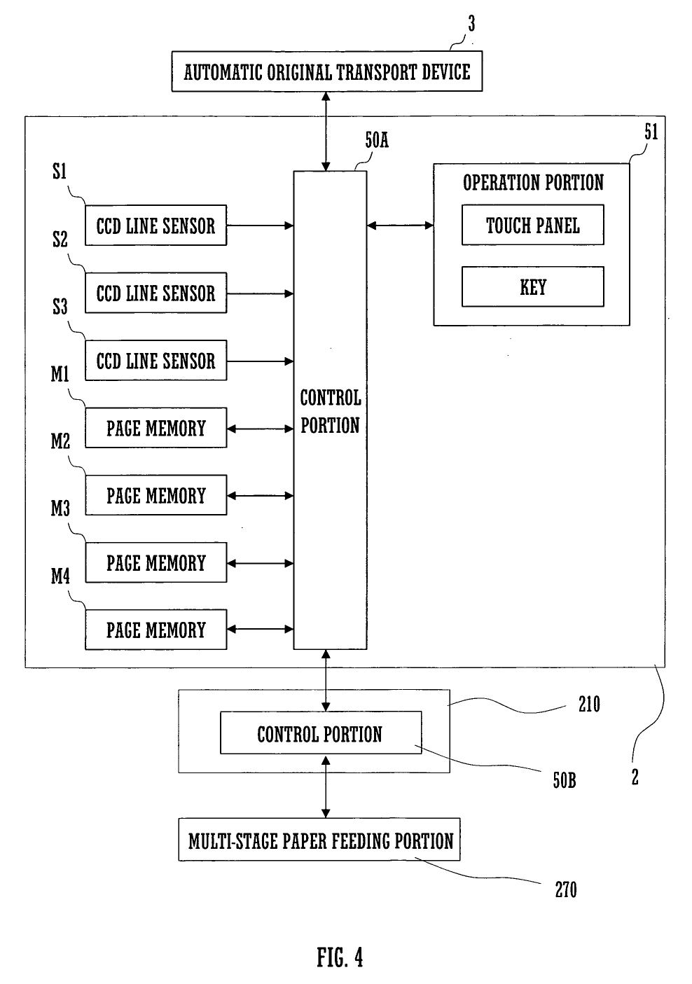

FIG. 4 is a block diagram schematically showing a configuration of the image forming apparatus 10. The image reading device 2 is provided with a control portion 50A. The control portion 50A is connected to a control portion 50B. The control portion 50B performs overall control of all parts of the image forming apparatus 10. The control portion 50A constitutes an image processing portion of the present invention. The control portion 50A creates image data relating to an image on an original, based on a plurality of temporary image data sets acquired by the CCD line sensors S1 to S3.

The control portion 50A is connected to an operation portion 51, the automatic original transport device 3, the image forming portion 210, the multi-stage paper feeding portion 270, the three CCD line sensors S1 to S3, and four page memories M1 to M4. The operation portion 51 is provided with a touch panel and operation keys. The page memory M1 stores image data acquired by the CCD line sensor S1. The page memory M2 stores image data acquired by the CCD line sensor S2. The page memory M3 stores image data acquired by the CCD line sensor S3. The page memory M4 stores image data obtained by a process of optimizing image data (described later).

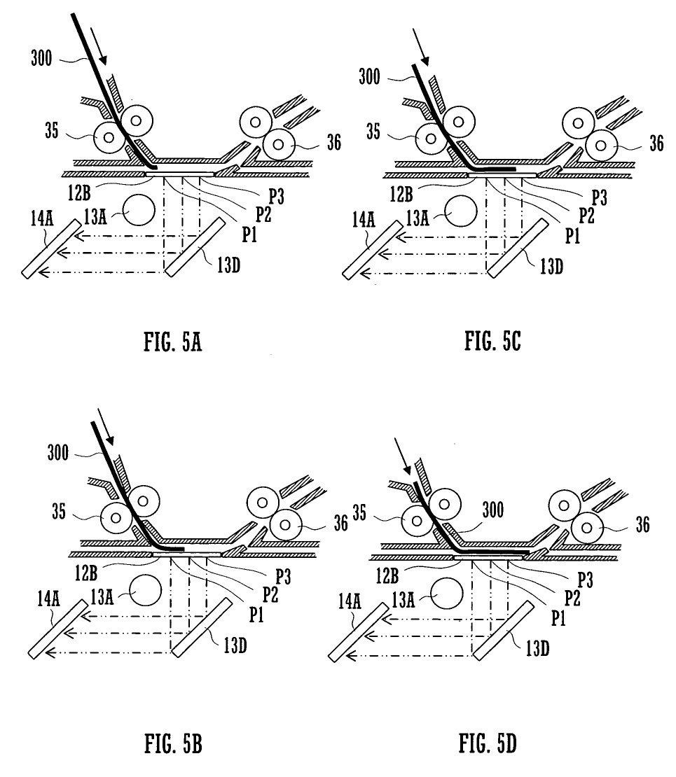

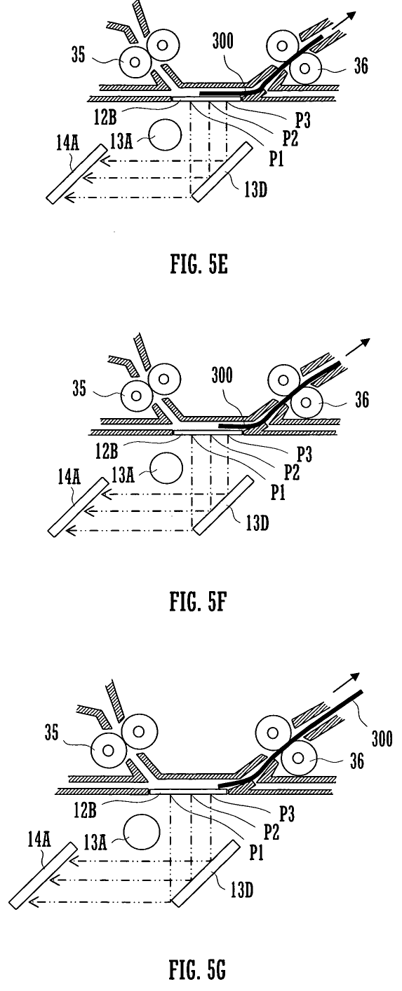

In this embodiment, FIG. 5A to FIG. 5G are explanatory diagrams showing how the image reading device 2 operates in the second reading mode. In the image reading device 2, an image on an original 300 that is transported onto the platen glass 12B is read by the three CCD line sensors S1 to S3 at the three image reading positions P1 to P3 respectively, which differ from each other in the original transport direction. In this embodiment, the image reading positions P1 to P3 are arranged in this order from the upstream of the original transport direction. FIG. 5A shows a state in which the front edge of the original 300 has not reached the image reading position P1. This state is referred to as a state A for the sake of explanation. FIG. 5B shows a state in which the front edge of the original 300 has passed the image reading position P1 and has not reached the image reading position P2. This state is referred to as a state B for the sake of explanation. FIG. 5C shows a state in which the front edge of the original 300 has passed the image reading position P2 and has not reached the image reading position P3. This state is referred to as a state C for the sake of explanation. FIG. 5D shows a state in which the front edge of the original 300 has passed the image reading position P3 and the rear edge of the original has not reached the image reading position P1. This state is referred to as a state D for the sake of explanation. FIG. 5E shows a state in which the rear edge of the original 300 has passed the image reading position P1 and has not reached the image reading position P2. This state is referred to as a state E for the sake of explanation. FIG. 5F shows a state in which the rear edge of the original 300 has passed the image reading position P2 and has not reached the image reading position P3. This state is referred to as a state F for the sake of explanation. FIG. 5G shows a state in which the rear edge of the original 300 has passed the image reading position P3. This state is referred to as a state G for the sake of explanation.

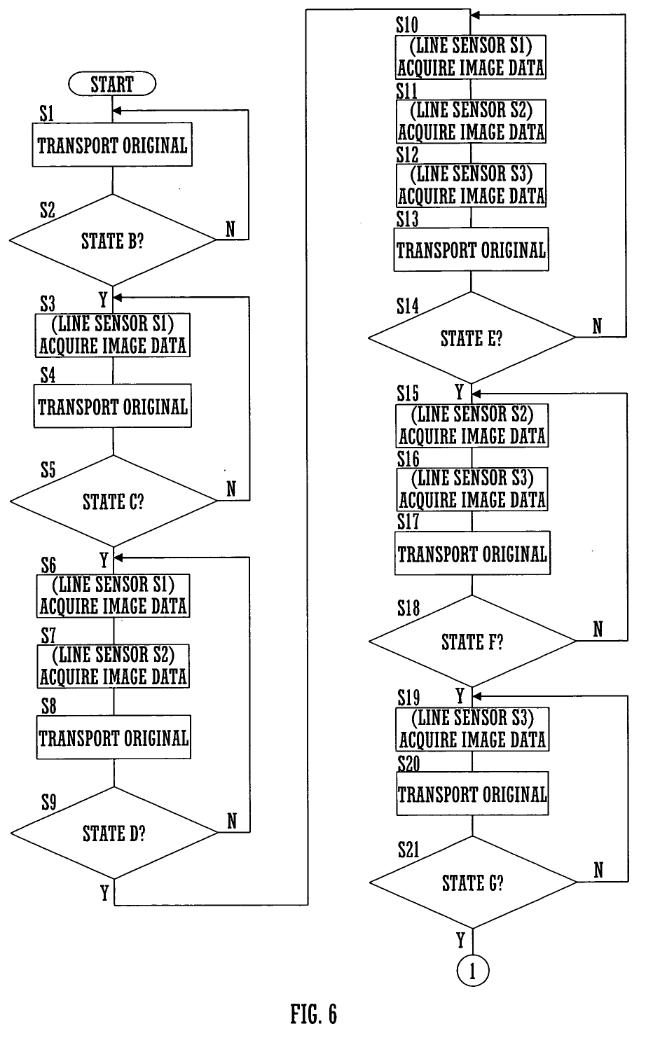

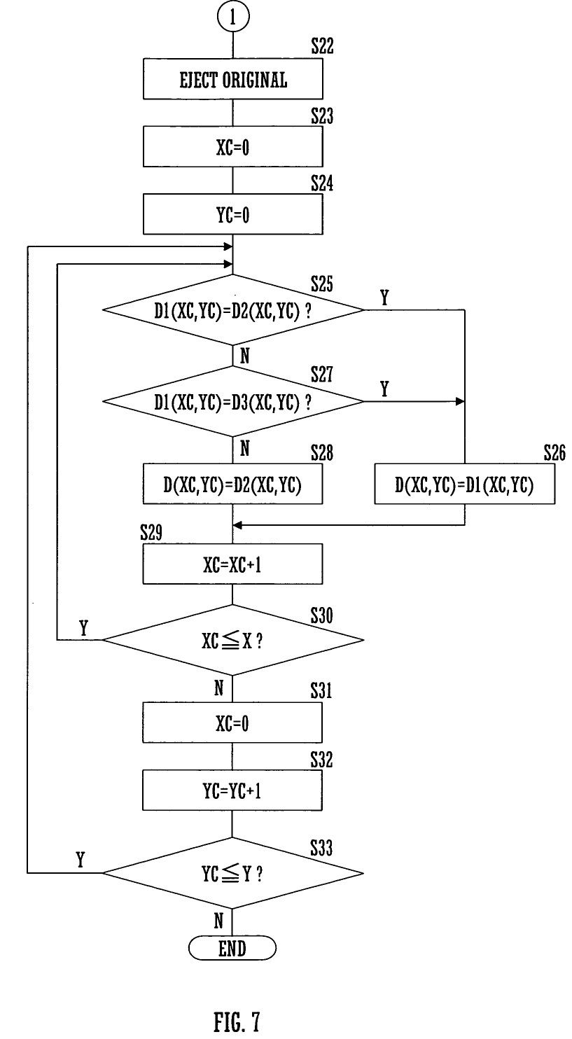

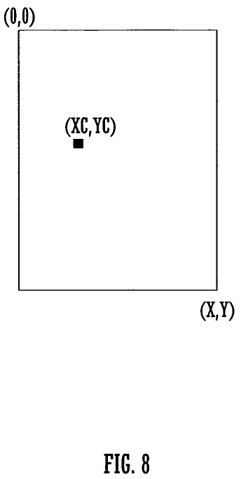

FIG. 6 and FIG. 7 are flowcharts showing the processing procedure performed by the control portion 50A of the image reading device 2. Herein, as shown in FIG. 8, the coordinates of pixels in the image data of the original 300 are shown by (XC, YC), the coordinates of the pixel corresponding to the most upper left position in the image on the original 300 are taken as (0, 0), and the coordinates of the pixel corresponding to the most lower right position are taken as (X, Y).

From the state A, the control portion 50A transports the original in the original transport direction in units of one line at a time (S1). The control portion 50A is on standby until the front edge of the original 300 reaches the image reading position P1 (S2).

In the standby step S2, when the front edge of the original 300 reaches the image reading position P1, the line sensor S1 acquires temporary image data relating to the image on the original, and the acquired temporary image data is stored in the page memory M1 (S3). Then, the control portion 50A transports the original 300 in the original transport direction by the amount of a further one line (S4).

Subsequently, the control portion 50A is on standby until the front edge of the original 300 reaches the image reading position P2 (S5). In the standby step S5, when the front edge of the original 300 reaches the image reading position P2, the line sensor S2 starts to acquire temporary image data of the original 300. The control portion 50A stores the temporary image data acquired by the line sensor S1 in the page memory M1 (S6), and stores the temporary image data acquired by the line sensor S2 in the page memory M2 (S7). Then, the control portion 50A transports the original 300 in the original transport direction by the amount of a further one line (S8).

Next, the control portion 50A is on standby until the front edge of the original 300 reaches the image reading position P3 (S9). In the standby step S9, when the front edge of the original 300 reaches the image reading position P3, the line sensor S3 starts to acquire temporary image data of the original 300. The control portion 50A stores the temporary image data acquired by the line sensor S1 in the page memory M1 (S10), stores the temporary image data acquired by the line sensor S2 in the page memory M2 (S11), and stores the temporary image data acquired by the line sensor S3 in the page memory M3 (S12). Then, the control portion 50A transports the original 300 in the original transport direction by the amount of a further one line (S13).

The control portion 50A is then on standby until the rear edge of the original 300 passes the image reading position P1 (S14). In the standby step S14, when the rear edge of the original 300 passes the image reading position P1, the line sensor S1 ends the acquisition of the temporary image data of the original 300. The control portion 50A stores the temporary image data acquired by the line sensor S2 in the page memory M2 (S15), and stores the temporary image data acquired by the line sensor S3 in the page memory M3 (S16). Then, the control portion 50A transports the original 300 in the original transport direction by the amount of a further one line (S17).

Next, the control portion 50A is on standby until the rear edge of the original 300 passes the image reading position P2 (S18). In the standby step S18, when the rear edge of the original 300 passes the image reading position P2, the line sensor S2 ends the acquisition of the temporary image data of the original 300. The control portion 50A stores the temporary image data acquired by the line sensor S3 in the page memory M3 (S19). Then, the control portion 50A transports the original 300 in the original transport direction by the amount of a further one line (S20).

Subsequently, the control portion 50A is on standby until the rear edge of the original 300 passes the image reading position P3 (S21). In the standby step S21, when the rear edge of the original 300 passes the image reading position P3, the process of discharging an original is performed on the original 300 (S22).

With steps S1 to S22, three temporary image data sets relating to the image on one original 300 are acquired.

The control portion 50A then compares the three acquired temporary image data sets for corresponding pixels, and creates image data relating to the image on the original 300 based on the result of the comparison. First, the control portion 50A sets a value “0” as the variable XC (S23), and sets a value “0” as the variable YC (S24). The control portion 50A then determines whether or not a value D1 (XC, YC) at the coordinates (XC, YC) of the temporary image data stored in the page memory M1 is the same as a value D2 (XC, YC) at the coordinates (XC, YC) of the temporary image data stored in the page memory M2 (S25). In this embodiment, in principal, if the same value is obtained at the coordinates of at least two temporary image data sets of the three temporary image data sets, this value is set as the image data of the original.

If the value D1 (XC, YC) is the same as the value D2 (XC, YC) in the determination step S25, then the value D1 (XC, YC) is set as the value D (XC, YC) at the coordinates (XC, YC) of the image data relating to the image on the original (S26). On the other hand, if the value D1 (XC, YC) is not the same as the value D2 (XC, YC) in the determination step S25, then the control portion 50A determines whether or not the value D1 (XC, YC) is the same as a value D3 (XC, YC) at the coordinates (XC, YC) of the temporary image data stored in the page memory M3 (S27). Herein, the reason why the value D1 (XC, YC) is not the same as the value D2 (XC, YC) may be that dirt or scratches are present at the image reading point P1 or the image reading point P2 on the platen glass 12B. Furthermore, also when a part of light receiving elements of the CCD line sensor S1 or S2 is out of order, the value D1 (XC, YC) will not match the value D2 (XC, YC).

If the value D1 (XC, YC) is the same as the value D3 (XC, YC) in the determination step S27, then the value D1 (XC, YC) is set as the value D (XC, YC) at the coordinates (XC, YC) of the image data relating to the image on the original (S26). On the other hand, if the value D1 (XC, YC) is not the same as the value D3 (XC, YC), then the value D2 (XC, YC) is set as the value D (XC, YC) at the coordinates (XC, YC) of the image data relating to the image on the original (S28). It should be noted that in step S28, the value D2 (XC, YC) and the value D3 (XC, YC) are treated as the same value. This is because the possibility is low in which dirt or scratches are present at all of the image reading positions P1 to P3 on the platen glass 12B, or in which all portions of the elements in the CCD line sensors S1 to S3 corresponding to the coordinates (XC, YC) are out of order.

Subsequently, the control portion 50A adds a value “1” to the variable XC (S29), and determines whether or not the variable XC after the addition exceeds X (S30). In the determination step S30, the control portion 50A determines whether or not the formation of the image data for one line in the X coordinate direction is completed.

If the variable XC is equal to or less than X in the determination step S30, the control portion 50A proceeds to the determination step S25. On the other hand, if the variable XC exceeds X in the determination step S30, then the control portion 50A sets a value “0” as the variable XC (S31), and adds a value “1” to the variable YC (S32). Subsequently, the control portion 50A determines whether or not the variable YC after the addition is equal to or less than Y (S33). If YC is equal to or less than Yin the determination step S33, the control portion 50A again proceeds to the determination step S25, and if YC exceeds Y, the control portion 50A is on standby until the next process is performed.

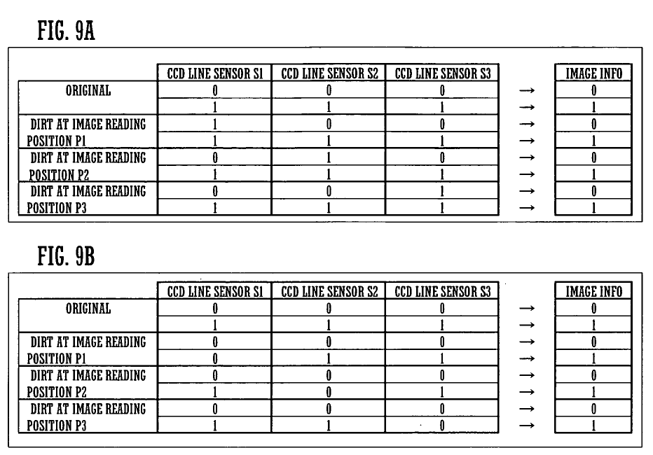

FIG. 9A and FIG. 9B show states in which pieces of dirt 400A to 400C are respectively present at the image reading positions P1 to P3 on the platen glass 12B.

As shown in FIG. 9A, when reading a white portion of an image on an original, all temporary image data sets acquired by the CCD line sensors S1 to S3 were to indicate “0”. On the other hand, when reading a black portion of an image on an original, all temporary image data sets acquired by the CCD line sensors S1 to S3 were to indicate “1”.

However, when the piece of dirt 400 C is present at the image reading position P1 on the platen glass 12B, there is the problem that in the temporary image data acquired by the CCD line sensor S1, the portion that should be “0” becomes “1” and a black streak appears in the image, or that the portion that should be “1” becomes “0” and a white streak appears in the image. A similar problem is caused by the piece of dirt 400 B present at the image reading position P2 or the piece of dirt 400 A present at the image reading position P3.

More specifically, when dirt or scratches are present on the platen glass 12B and light reflected from the original 300 does not reach the CCD line sensor because it is continuously blocked from passing through the dirt or scratches on the platen glass 12B, a value indicating black is always obtained in the image data relating to the image on the original 300 even if it is not a black portion in the image on the original. On the contrary, when light is always incident on the CCD line sensor because it is refracted due to scratches present on the platen glass 12B, a value indicating white is always obtained in the image data even if it is a black portion in the image on the original.

For pixels at one position in the main scanning direction, if the same value is obtained over the entire range in the direction corresponding to the original transport direction, then there is a possibility that dirt or scratches are present on the platen glass 12B. It is also conceivable that an element at the position corresponding to the CCD line sensor is out of order. For this reason, when creating image data, the control portion 50A does not use temporary image data in which a black streak or a white streak appears.

It is also possible to confirm the position of a pixel in the main scanning direction at which a black streak or a white streak appears, that is, the pixel in the main scanning direction on which dirt or the like is present on the platen glass 12B, or the pixel in the main scanning direction on which an element of the CCD line sensor is out of order, during shading compensation. More specifically, it is possible to store initial shading compensation data, which is thought to have no dirt, for example, and to compare that initial shading compensation data with shading compensation data that has been obtained later.

It should be noted that it is also possible to set the CCD line sensors S1 to S3 such that the fewer pixels they contain in the main scanning direction that are dirty or scratched, the higher their priority is, and then to select, from temporary image data sets whose value of a pixel at any one position in the image is judged to be the same, the temporary image data acquired by the CCD sensor with the highest priority to be the image information for that pixel.

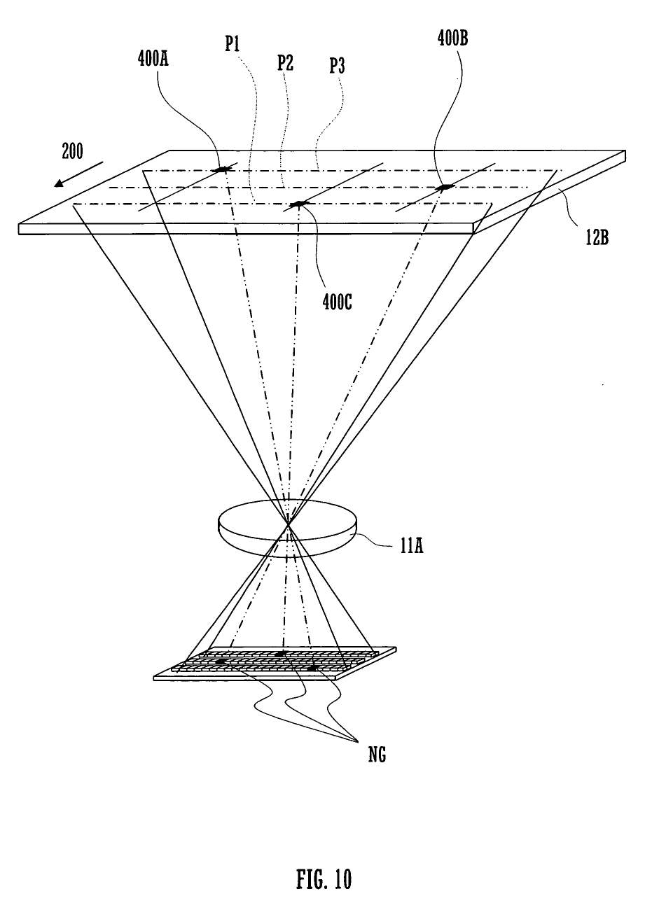

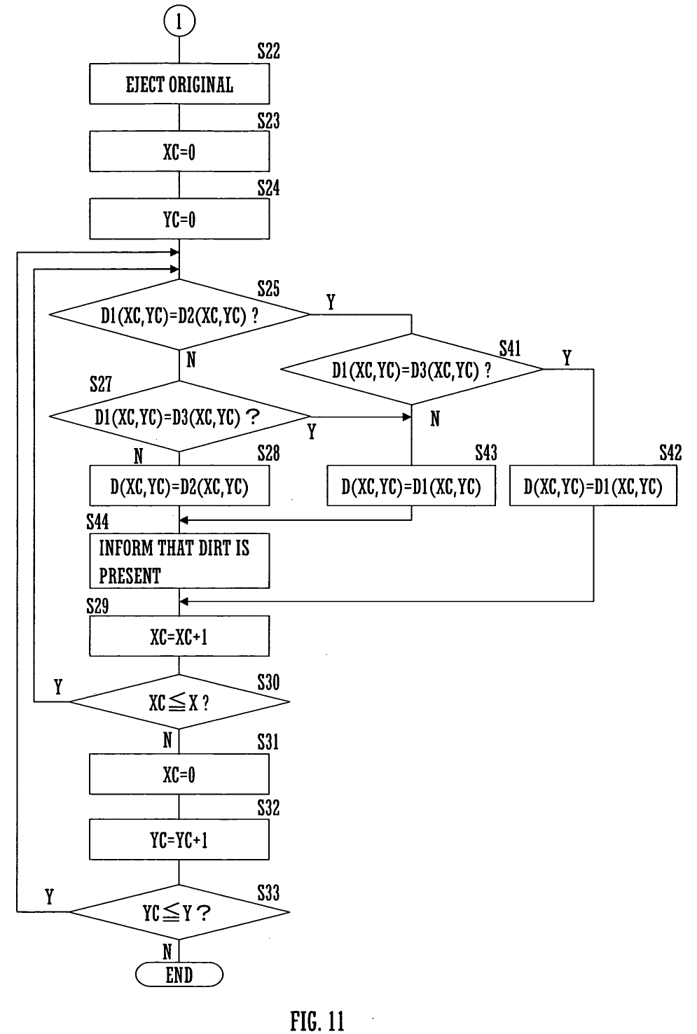

FIG. 10 is a perspective view schematically showing the structure of a part of the image reading device 2. As described above, when the pieces of dirt 400A to 400C are present on the platen glass 12B, temporary image data acquired by the elements of the CCD line sensors S1 to S3 corresponding to pixels on which the pieces of dirt 400A to 400C are present is inaccurate and is not used for forming the image information.

FIG. 11 is a flowchart showing the processing procedure performed by the control portion 50A according to a second embodiment. The steps S1 to S22 in the second embodiment are the same as the steps S1 to S22 in the first embodiment shown in FIG. 6. In the second embodiment, in the process in S25, the control portion 50A determines whether or not the value D1 (XC, YC) is to the same as the value D2 (XC, YC) (S25), and when they are the same as each other, the control portion 50A further determines whether or not the value D1 (XC, YC) is to the same as the value D3 (XC, YC) (S41). If the value D1 (XC, YC) is to the same as the value D3 (XC, YC) in the determination step S41, then the control portion 50A sets the value D1 (XC, YC) as the image data D (XC, YC) (S42). On the other hand, if the value D1 (XC, YC) is not the same as the value D3 (XC, YC) in the determination step S41, then the control portion 50A sets the value D1 (XC, YC) as the image data D (XC, YC) (S43). Furthermore, the control portion 50A displays, on the touch panel of the operation portion 51, a message that dirt is present at the position of the coordinate XC on the platen glass 12B (S44).

If the value D1 (XC, YC) is not to the same as the value D2 (XC, YC) in the determination step S25, then the control portion 50A further determines whether or not the value D1 (XC, YC) is to the same as the value D3 (XC, YC) (S27). If the value D1 (XC, YC) is the same as the value D3 (XC, YC) in the determination step S27, then the procedure proceeds to step S43. On the other hand, if the value D1 (XC, YC) is not the same as the value D3 (XC, YC) in the determination step S27, then the control portion 50A sets the value D2 (XC, YC) as the image data D (XC, YC) and then proceeds to step S44.

According to the second embodiment, the user can easily confirm that dirt or the like is present on the platen glass 12B.

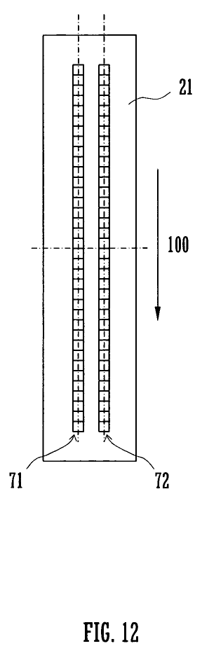

In the aforementioned embodiments, the CCD image sensor 11B having the three CCD line sensors S1 to S3 formed in one piece is used, but the image sensor is not limited to the configuration. Instead of the CCD image sensor 11B, a CCD image sensor 21 provided with two CCD line sensors 71 and 72 formed in one piece as shown in FIG. 12 also may be used. In addition, the number of the CCD line sensors provided may be four or more.

In the aforementioned embodiments, a configuration is adopted in which temporary image data for one image acquired by each of the CCD line sensors S1 to S3 is stored in each of the page memories M1 to M3, and then the temporary image data is compared with each other to form image information, but the configuration is not limited to the configuration. A, configuration may be also adopted, for example, in which temporary image data is retained in a buffer memory or the like and a delay circuit is provided, the temporary image data is acquired by each of the CCD line sensors S1 to S3, and at the same time, the acquired temporary image data is compared with each other to form image information that is to be output to, for example, the image forming portion 210.

Furthermore, instead of selecting one temporary image data set from among temporary image data sets that are judged to be equal to each other from among a plurality of temporary image data sets, with respect to the same pixel in the image, the plurality of acquired temporary image data sets may be averaged or the plurality of temporary image data sets may be weighted in a predetermined manner, with respect to each pixel in the image, to form image information.

In FIG. 1, the platen glass 12A on which an original at rest is placed, and the platen glass 12B on which an original is transported and read, are shown as two separate transparent glass plates, but they can be constituted as a single transparent glass plate.

Finally, the embodiments described above are to be considered in all respects as illustrative and not limiting. The scope of the invention is indicated by the appended claims rather than by the foregoing embodiments. Furthermore, all changes which come within the meaning and range of equivalency of the claims are intended to be embraced in the scope of the invention.

What is claimed is:

1. An image reading device provided with a function for reading an image on an original that is being transported on an original transport path, comprising:
a plurality of image reading portions for reading the image on the original that is being transported on the original transport path, in positions that mutually differ in the original transport direction, the image reading portions each being provided with a plurality of light receiving elements that are each lined up in a main scanning direction perpendicular to an original transport direction;
a storage portion for storing, as temporary image data, each of the image data sets relating to the image on the original, obtained through the image reading portions; and
an image processing portion for comparing value of each corresponding pixel of the temporary image data sets, and for creating image data relating to the image on the original based on a result of the comparison.

2. The image reading device according to claim 1, wherein when the same value is obtained for corresponding pixels of at least two temporary image data sets, the image processing portion sets the value as the image data relating to the image on the original.

3. The image reading device according to claim 2, wherein when the same value is obtained at all pixels arranged continuously along a direction corresponding to the original transport direction in temporary image data acquired by any one of the image reading portions, the image processing portion operates without consideration to the temporary image data acquired by the image reading portion.

4. The image reading device according to claim 3, wherein the image reading portions are a plurality of line sensors configured in one piece.

5. An image forming apparatus, comprising:
an image reading device having a function for reading an image on an original that is being transported on an original transport path, the image reading device including:
a plurality of image reading portions for reading the image on the original that is being transported on the original transport path, in positions that mutually differ in the original transport direction, the image reading portions each being provided with a plurality of light receiving elements that are each lined up in a main scanning direction perpendicular to an original transport direction;
a storage portion for storing, as temporary image data, each of the image data sets relating to the image on the original, obtained through the image reading portions; and
an image processing portion for comparing the value of each corresponding pixel of the temporary image data sets, and for creating image data relating to the image on the original based on a result of the comparison, and
an image forming portion for forming an image on a recording medium based on the image data relating to the image on the original created by the image reading device.
